(19) United States
(12) Patent Application Publication
(10) Pub. No.: US 2026/0073439 A1
(43) Pub. Date: Mar. 12, 2026

(54) PRODUCT MANAGEMENT DEVICE, PRODUCT MANAGEMENT METHOD, AND RECORDING MEDIUM

(71) Applicant: NEC Corporation, Minato-ku, Tokyo (JP)

(72) Inventors: Ning LI, Tokyo (JP); Takashi TACHIKAWA, Tokyo (JP)

(73) Assignee: NEC Corporation, Minato-ku, Tokyo (JP)

(21) Appl. No.: 19/106,321

(22) PCT Filed: Nov. 14, 2022
(86) PCT No.: PCT/JP2022/042167

§ 371 Date: Feb. 25, 2025

(51) Int. Cl. G06Q 30/0601

(52) U.S. Cl. CPC G06Q 30/06291; G06Q 30/06435

(57) ABSTRACT

Provided is a product management device comprising: an acquisition means that acquires sensor information containing information relating to a plurality of displayed identical products; a state estimation means that estimates, on the basis of the sensor information, an individual state of each of the plurality of individual identical displayed products; an extraction means that extracts, on the basis of the individual state of each of the plurality of identical products, from the plurality of individual identical products, a specific product that is an individual product having a relatively different individual state; and an output means that outputs specific product information relating to the specific product.

### TECHNICAL FIELD

The present disclosure relates to a technique for managing individual products, and the like.

### BACKGROUND ART

PTL 1 describes a technique for determining discount information according to a state of a product and a sales deadline.

### CITATION LIST

### Patent Literature

PTL 1: JP 2021-48231 A

### SUMMARY OF INVENTION

### Technical Problem

There may be individual differences even in the same products. Sales of products having individual differences may be affected unless price setting or display is appropriately performed. Therefore, it is difficult to manage a plurality of products having individual differences.

An object of the present disclosure is to provide a technology that enables management of a plurality of identical products according to individual differences.

### Solution to Problem

A product management device according to an aspect of the present disclosure includes: an acquisition means that acquires sensor information containing information relating to a plurality of displayed identical products; a state estimation means that estimates, based on the sensor information, an individual state of each of the plurality of individual identical displayed products; an extraction means that extracts, based on the individual state of each of the plurality of identical products, from the plurality of individual identical products, a specific product that is an individual product having a relatively different individual state; and an output means that outputs specific product information relating to the specific product.

A product management method according to an aspect of the present disclosure causes a computer to execute: acquiring sensor information containing a plurality of displayed identical products; estimating, based on the sensor information, an individual state of an individual product of each of the plurality of displayed individual identical products; extracting a specific product that is an individual product having a relatively different individual state from the plurality of individual identical products based on the individual state of each of the plurality of identical products; and outputting specific product information relating to the specific product.

A recording medium according to an aspect of the present disclosure has stored therein a program to cause a computer to execute: acquiring sensor information containing a plurality of displayed identical products; estimating, based on the sensor information, an individual state of an individual product of each of the plurality of displayed individual identical products; extracting a specific product that is an individual product having a relatively different individual state from the plurality of individual identical products based on the individual state of each of the plurality of identical products; and outputting specific product information relating to the specific product.

### Advantageous Effects of Invention

One example of an effect of the present disclosure is that a plurality of the identical products can be managed according to individual differences.

### BRIEF DESCRIPTION OF DRAWINGS

FIG. 1 is a block diagram illustrating a configuration of a product management device in a first example embodiment.

FIG. 2 is a flowchart illustrating an operation of the product management device according to the first example embodiment.

FIG. 3 is a block diagram illustrating a configuration of a product management device according to a second example embodiment.

FIG. 4 is a diagram illustrating an example of price information according to the second example embodiment.

FIG. 5 is a diagram illustrating an output example in the second example embodiment.

FIG. 6 is a flowchart illustrating an operation of the product management device according to the second example embodiment.

FIG. 7 is a block diagram illustrating a configuration of a product management device in a first modification.

FIG. 8 is a block diagram illustrating a configuration of a product management device in a second modification.

FIG. 9 is a diagram illustrating an output example in the second modification.

FIG. 10 is a diagram illustrating a hardware configuration in which the product management device according to the present disclosure is implemented by a computer device and its peripheral devices.

### EXAMPLE EMBODIMENTS

Hereinafter, example embodiments of the present disclosure will be described in detail with reference to the drawings.

In the following example embodiments of the present disclosure, each product management device may be implemented by a terminal device used by a customer or a store clerk in a store, a combination of the terminal device and a server connected to the terminal device via a network, or a server. The user who uses the terminal device is, for example, a store clerk or a customer of the store.

Each product management device manages a product displayed on a product shelf or a box in a selling area of a store, a product placed as a stock in a backyard of the store, or a product displayed in a market in which purchasing is performed. These products are referred to as displayed products. In each of the following example embodiments and modifications, processing related to a displayed product on a product shelf in a selling area of a store will be mainly described. However, the description of each of the example embodiments and modifications may be appropriately replaced with another displayed product. A plurality of the identical products are collectively displayed at one to several places. The identical products are the same type of products. The same type of products is, for example, a product having the same product identification information. The product identification information is, for example, information specifying a type of a product, such as an identification number included in a bar code.

In the following example embodiments and modifications, the management of the product is management related to sales of products, such as setting (change) of a price, determination of a display place, and management of sales. In sales of products, ease of sale and difficulty in sale may vary depending on individual differences. Therefore, it is required to perform management according to individual differences of products. For example, an individual difference of a product having a large change in quality over time affects a customer's purchasing activity and a product sales activity. A product having a large change in quality over time is, for example, a food. An electrical appliance generally has a smaller change in quality over time than food. Therefore, in each of the following example embodiments and modifications, management of a food product having a large change in quality over time will be mainly described. However, the product to be managed is not particularly limited, and may be a product other than food.

### First Example Embodiment

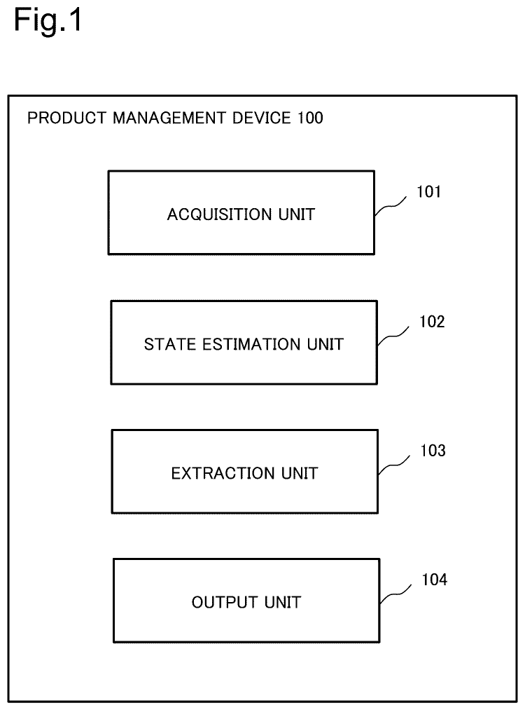

FIG. 1 is a block diagram illustrating a configuration of a product management device 100 in a first example embodiment. Referring to FIG. 1, the product management device 100 includes an acquisition unit 101, a state estimation unit 102, an extraction unit 103, and an output unit 104.

Next, a configuration of the product management device 100 according to the first example embodiment will be described in detail.

In FIG. 1, the acquisition unit 101 is an example of an acquisition means that acquires sensor information containing a plurality of displayed identical products. The plurality of displayed identical products is, for example, a displayed product on a product shelf or a box in a selling area of a store, a product placed as a stock in a backyard of the store, or a displayed product in a market in which purchasing is performed. The sensor information containing the plurality of displayed identical products is sensor information containing some or all of the plurality of displayed identical products. The sensor information is two-dimensional data or three-dimensional data. The sensor information may be a combination of two-dimensional data and three-dimensional data. The two-dimensional data is, for example, image data captured by a camera. The three-dimensional data is, for example, data including a distance acquired by a distance measuring sensor. The distance measuring sensor is, for example, a time of flight (TOF) distance measuring sensor, but is not limited thereto. Hereinafter, an example in which an image is mainly used as the sensor information will be described. However, also in a case where three-dimensional data or a combination of an image and three-dimensional data is used as the sensor information, processing may be performed similarly to the case of an image. The image including the plurality of displayed identical products may include product information relating to the displayed product such as a bar code or a label.

The acquisition unit 101 acquires sensor information containing a plurality of displayed identical products from the sensor. The sensor is, for example, a camera that detects two-dimensional data or a distance measuring sensor that detects three-dimensional data. Alternatively, the acquisition unit 101 may acquire the sensor information containing the plurality of displayed identical products from a storage unit to which the information has been transmitted from the sensor and stored. The camera may be a sensor installed in a store or a sensor provided in a terminal device. The sensor installed in the store is connected to, for example, the product management device 100 via a network. The timing at which the acquisition unit 101 acquires the sensor information is not particularly limited. For example, the acquisition unit 101 acquires sensor information in accordance with a user's instruction. Alternatively, the acquisition unit 101 may acquire the sensed sensor information at predetermined time intervals.

The state estimation unit 102 is an example of a state estimation means that estimates the individual state of the individual product of each of the plurality of displayed identical products based on the sensor information. Hereinafter, an example in which the state estimation unit 102 estimates the individual state of the individual product of each of the plurality of displayed identical products based on the image will be mainly described. The individual state is, for example, at least one of the size of the individual product, the color of the individual product, the presence or absence of a flaw of the individual product, the shape of the individual product, the presence or absence of unevenness of the individual product, the best-before date of the individual product, or the arrival date of the individual product. The individual states may each include a degree of flaw of the individual product or a degree of unevenness of the individual product. Here, the degree may be, for example, a size or a number. The degree of flaw of the individual product may be poor in color.

For example, the state estimation unit 102 estimates the size of the individual product, the color of the individual product, the presence or absence of a flaw of the individual product, and the shape of the individual product based on the image acquired by the acquisition unit 101. For example, the state estimation unit 102 first specifies a plurality of displayed identical products. For example, specifying the plurality of displayed identical products means specifying product identification information of the plurality of displayed identical products. Next, the state estimation unit 102 detects the individual product based on the image acquired by the acquisition unit 101. Here, the detection of the individual product is an image region of each individual product in the image. A known image recognition technique may be used to detect an individual product. For example, the state estimation unit 102 detects the contour of the individual product in the image. Then, the state estimation unit 102 estimates the individual state of each individual product based on the pixel information of each individual product. The state estimation unit 102 may estimate the individual state of each individual product by another method.

An example of a method of specifying a plurality of displayed identical products by the state estimation unit 102 will be described. First, a case where the acquisition unit 101 acquires an image captured by a camera in a store will be described. In this case, the state estimation unit 102 specifies a plurality of the displayed identical products included in the image based on, for example, a position and a capturing direction of a camera installed in the store. For example, the identification information of the camera installed in the store, the information of the position of the camera and the capturing direction, and the identification information of the products arranged in the range captured by the position of the camera and the capturing direction are associated in advance and stored in a storage unit (not illustrated). The storage unit (not illustrated) may be provided inside the product management device or outside communicably connected to the product management device. The state estimation unit 102 may specify a plurality of the identical products included in the image from the identification information of the camera from which the acquisition unit 101 has acquired the image by referring to the storage unit. In a case where the capturing direction of the camera can be changed, the acquisition unit 101 acquires the capturing direction of the camera in addition to the image and the identification information of the camera that has acquired the image. The identification of the plurality of displayed identical products included in the image may be performed by other methods.

Next, another example of a method of specifying a plurality of displayed identical products by the state estimation unit 102 will be described. For example, the acquisition unit 101 may acquire the product identification information of the product included in the captured image input by the user with the terminal device at the time of photographing in association with the image. For example, the acquisition unit 101 may acquire, from the camera in the store, an image in which a product designated by the operation of the terminal device by the user is captured. In this case, by referring to the storage unit, the acquisition unit 101 instructs a camera capable of capturing the designated product from the product identification information of the product designated by the operation of the terminal device by the user to capture an image including a plurality of the displayed identical products. In a case where the capturing direction of the camera is changeable, the capturing instruction includes the capturing direction. Next, the acquisition unit 101 acquires an image including a plurality of displayed identical products as the products designated by the operation of the terminal device by the user. Then, the state estimation unit 102 specifies the plurality of displayed identical products based on the image captured by the camera in the store and acquired by the acquisition unit 101 and the product designated by the operation of the terminal device by the user associated with the image. For example, the acquisition unit 101 acquires, from the terminal device, information indicating a product designated by an operation of the terminal device by the user, and an image including a plurality of displayed identical products and captured by the terminal device. Then, the state estimation unit 102 may specify the plurality of displayed identical products based on the image captured by the camera of the terminal device and the product designated by the operation of the terminal device by the user associated with the image acquired by the acquisition unit 101.

Furthermore, another example of a method of specifying a plurality of displayed identical products by the state estimation unit 102 will be described. The state estimation unit 102 may specify a product by information of characters or a bar code of a price label of a product shelf included in an image including a plurality of displayed identical products or another image acquired in association with an image including a plurality of displayed identical products. For example, the state estimation unit 102 may recognize characters included in an image by character recognition. The state estimation unit 102 may specify the name of the product included in the product information database with which the name of the product and the identification information of the product are associated among the recognized characters as the names of the plurality of displayed identical products. For example, the state estimation unit 102 reads a bar code included in the image. The state estimation unit 102 may specify the character string read from the bar code as the product identification numbers of the plurality of displayed identical products.

In the estimation of the individual state by the state estimation unit 102, the state estimation unit 102 detects the image region of the individual product after specifying the plurality of displayed identical products included in the image.

The state estimation unit 102 detects each of the plurality of displayed identical products specified in the above-described specifying processing from the acquired image using, for example, deep learning or another image analysis method. Specifically, the state estimation unit 102 detects image regions of the plurality of identical products included in the acquired image. The state estimation unit 102 detects an image region of an individual product of each of the plurality of identical products among the plurality of detected image regions of the identical product. For example, the state estimation unit 102 may detect the contour of each individual product.

In the estimation of the individual state by the state estimation unit 102, the state estimation unit 102 estimates the individual state of the individual product after specifying the plurality of displayed identical products included in the image and detecting the image region of the individual product.

The state estimation unit 102 estimates at least one of the size of the individual product, the shape of the individual product, and the color of the individual product as the individual state from the data of the image region of the individual product. The information indicating the size of the individual product and the information indicating the shape of the individual product may be information indicating the contour of the individual product. The information indicating the color may be an RGB value, brightness, chroma, or the like. Here, there is a case where only a part of the individual product is shown in the image including the plurality of displayed identical products. In this case, the state estimation unit 102 estimates the state of the product in an image region of a part of the individual product appearing in the image. The individual state may include information indicating that all of the individual products are not shown, that is, the estimation of the individual state is incomplete.

The state estimation unit 102 may further estimate the individual state based on the information indicating the contour of the individual product or the information indicating the color of the individual product described above. For example, the state estimation unit 102 may estimate the presence or absence of unevenness as information indicating the shape of the individual product. Since it is assumed that a shadow is formed in the recess of the product, the state estimation unit 102 may estimate the presence or absence of the unevenness of the individual product by determining that a pixel having lower brightness than surrounding pixels is the recess based on the information indicating the color of the pixel in the image region of the individual product. For example, the state estimation unit 102 may estimate the presence or absence of a flaw of an individual product by determining that a region of a pixel having an RGB value significantly different from those of surrounding pixels is a flaw based on information indicating the color of the pixel in the image region of the individual product. The estimation of the presence or absence of unevenness of the individual product and the estimation of the presence or absence of a flaw of the individual product may be performed by the extraction unit 103 described later.

The state estimation unit 102 may estimate the individual state based on the image acquired by the acquisition unit 101 using a learned model. For example, the learned model is generated in advance by executing learning processing by machine learning using an image of a product without a flaw, an image of a product with a flaw, an image of a product with a good color, an image of a product with a bad color, an image of a product with a good shape, and an image of a product with a bad shape as teacher data. In estimating the individual state, the state estimation unit 102 inputs an image of a product to the learned model. The learned model outputs an individual state such as the presence or absence of a flaw, the quality of color, and the quality of shape of a product included in an image region of the individual product. Then, the state estimation unit 102 sets the output individual state as an estimation result.

The state estimation unit 102 may estimate a best-before date or an arrival date as the individual state of the individual product based on the image acquired by the acquisition unit 101. For example, the state estimation unit 102 may estimate the best-before date or the arrival date of the individual product by recognizing characters printed on the label of the individual product included in the image. For example, the state estimation unit 102 may acquire the best-before date or the arrival date of the individual product associated with the two-dimensional code by reading the two-dimensional code printed on the label of the individual product included in the image.

The state estimation unit 102 may add environment information relating to an environment in which products are displayed to the individual state. The environment information relating to the environment in which products are displayed is, for example, temperature or humidity received from a sensor (not illustrated). The environment information may include the presence or absence of sunlight. These pieces of environment information change according to a place where products are displayed. In general, even the identical products may be displayed in different environments. The place where the products are displayed is, for example, a product displayed indoors, a product displayed outdoors, or a product displayed in a refrigerator.

In this case, the state estimation unit 102 specifies the display place of the individual product. That is, the state estimation unit 102 may specify a place where an image including a plurality of displayed identical products is captured. In a case where the camera from which the acquisition unit 101 acquires the image is a camera installed in the store, the state estimation unit 102 may specify the display place of the products included in the acquired image from the information indicating the position and capturing direction of the camera in the acquired image based on the information of the position and capturing direction of the camera installed in the store and the information of the place where the image is captured in the position and capturing direction of the camera stored in advance. For example, the state estimation unit 102 may specify the display place based on the information of the captured place input by the user at the time of capturing and the image acquired by the acquisition unit 101.

Although the example of using an image as the sensor information has been described so far, the state estimation unit 102 may estimate the individual state based on three-dimensional data including a plurality of displayed individual products. Alternatively, the state estimation unit 102 may estimate the individual state based on an image including a plurality of displayed individual products and three-dimensional data including a plurality of displayed individual products. In a case where the state estimation unit 102 estimates the individual state using the three-dimensional data, it is possible to more accurately estimate the size, volume, and recess of the individual product among the individual states.

The extraction unit 103 is an example of an extraction means that extracts an individual product having a relatively different individual state from the plurality of individual identical products as a specific product based on the individual state of each of the plurality of identical products. The specific product is an individual product having a relatively different individual state among a plurality of identical products. The product having a relatively different individual state may be a product having a poor individual state or a product having an excellent individual state among a plurality of identical products. The product management device 100 manages a specific product and an individual product other than the specific product. For example, the extraction unit 103 compares individual states of a plurality of identical products to extract an individual product having a relatively poor individual state among the plurality of identical products as a specific product. For example, the extraction unit 103 may compare individual states of a plurality of identical products to extract an individual product having a good individual state as a specific product. The extraction unit 103 can extract a specific product by extracting the specific product having a relatively different individual state based on the individual state of each of the plurality of identical products in consideration of the state of the entire plurality of identical products that changes depending on the period, timing, or the like.

For example, even if the products have the same best-before date, the products may have different salability depending on whether the best-before date of the identical product displayed around at the time of sale is a closer expiration date or an earlier expiration date. For example, a product whose best-before date is October 5 is assumed to be a product that is easy to sell when the best-before dates of many surrounding products are October 3. On the other hand, a product whose best-before date is October 5 is assumed to be unlikely to sell when the best-before dates of many surrounding products are October 7.

Similarly, even if the products have the same degree of ripeness, the salability may differ depending on the degree of ripeness of the identical product displayed around at the time of sale. The size and color of a product such as a fruit or vegetable may change depending on the period. For example, in a case where many surrounding bananas are brown, a banana that starts to have brown spots and is ready to eat is assumed to be a product that is easy to sell because it has a relatively long shelf life. On the other hand, in a case where many surrounding bananas are not completely ripe and have a greenish yellow color, a banana that also starts to have brown spots and is ready to eat is assumed to be a product that is unlikely to sell because the bananas have a relatively short shelf life.

The extraction unit 103 extracts a specific product having a relatively different individual state with respect to a product whose salability relatively changes, thereby making it possible to appropriately manage the individual product according to the state and individual difference of the plurality of identical products that change depending on the period, timing, and the like.

For example, the extraction unit 103 may extract a specific product by comparing a criterion based on the individual state of the individual product with the individual state of the individual product. The criterion based on the individual state of the individual product is a criterion calculated based on the entire individual state of the individual product that is each of the plurality of displayed identical products included in the image. The criterion based on the individual state of the individual product is a relative criterion with respect to the individual product that is each of the plurality of displayed identical products included in the image. An average value of individual states of individual products in a plurality of displayed identical products is exemplified. The relative criterion may be calculated by the state estimation unit 102 or the extraction unit 103. For example, the extraction unit 103 compares the criterion with the individual state of each individual product to extract a specific product that is likely to sell well. For example, the specific product that is likely to sell well is a product having an appropriate size, a large product, a product having no flaw, a product having a good color, or a product having a good shape. A product whose size is appropriate is an item whose size is within a predetermined range. Alternatively, the extraction unit 103 may extract a specific product that is unlikely to sell based on the criteria. For example, a specific product that is unlikely to sell is a product that is not appropriate in size, a small product, a flawed product, a product that is poor in color, or a product that is poor in shape.

The criterion may be a reference value or a reference value range of each individual state for each identical product. For example, the criterion is a reference value or a reference value range representing the size, shape, or color of the individual product. The extraction unit 103 may extract a specific product using an absolute criterion in addition to a relative criterion. The absolute criterion is a preset absolute criterion. The absolute criterion is, for example, a preset range of pixel values indicating an appropriate color of bananas.

In a case where the individual state estimated by the state estimation unit 102 is binary identification information indicating whether the size is appropriate or inappropriate, the size is large or small, the color is good or bad, or the shape is good or bad, or binary identification information indicating the presence or absence of a flaw or the presence or absence of unevenness, the criterion is unnecessary. The binary identification information may be, for example, the presence or absence of a flag. In this case, the extraction unit 103 is only required to extract, as a specific product, an individual product having an unsuitable size, a bad color, a bad shape, or a flaw or unevenness based on information indicating that the size is unsuitable, the color is bad, the shape is bad, or the flaw or unevenness is present. In a case where the state estimation unit 102 estimates, as an individual state, a value or a plurality of levels indicating the size of the individual product, the color of the individual product, the shape of the individual product, the degree of flaw of the individual product, or the degree of unevenness of the individual product, the extraction unit 103 compares the individual product with the values or the levels using a criterion for determining that the individual product is the specific product in a predetermined state, and extracts the specific product.

The output unit 104 is an example of an output means that outputs the specific product information relating to the specific product. The output unit 104 outputs the specific product information to a store clerk or customer who is a user. For example, the output unit 104 outputs the specific product information to a display unit of a terminal device used by a customer or a store clerk of the store.

The output unit 104 may output that there is a specific product having a relatively different individual state as the specific product information. Alternatively, the output unit 104 may output information that can identify the specific product and the individual state of the specific product as the specific product information. The information that can identify the specific product is, for example, an image in which a symbol indicating the specific product is superimposed on an image including a plurality of identical products. The information that can identify the specific product may be, for example, an image in which the specific product is circled in an image including a plurality of the identical products. The output unit 104 may output information that can identify the specific product and information relating to management of the specific product. For example, the output unit 104 may output, to the customer, information that can identify the specific product and a price set for the specific product as the specific product information. For example, the output unit 104 may output information that can identify the specific product and an appropriate display place of the specific product to the store clerk as the specific product information. The output example of the output unit 104 is not limited thereto.

For example, the output unit 104 may project the specific product information on a display place of a product that is an image capturing range. That is, the output unit 104 outputs the specific product information to a projector capable of projecting an image on a display place of a product that is an image capturing range. For example, the output unit 104 may superimpose and display the specific product information on the image of the displayed specific product.

Alternatively, the specific product information output by the output unit 104 may include identification information of the specific product. The identification information of the specific product may be information that can identify the specific product from the identical product. The identification information of the specific product is, for example, an identification number. The identification information of the specific product may be an image of the specific product. In this case, the image of the specific product may include an appearance characteristic of the specific product.

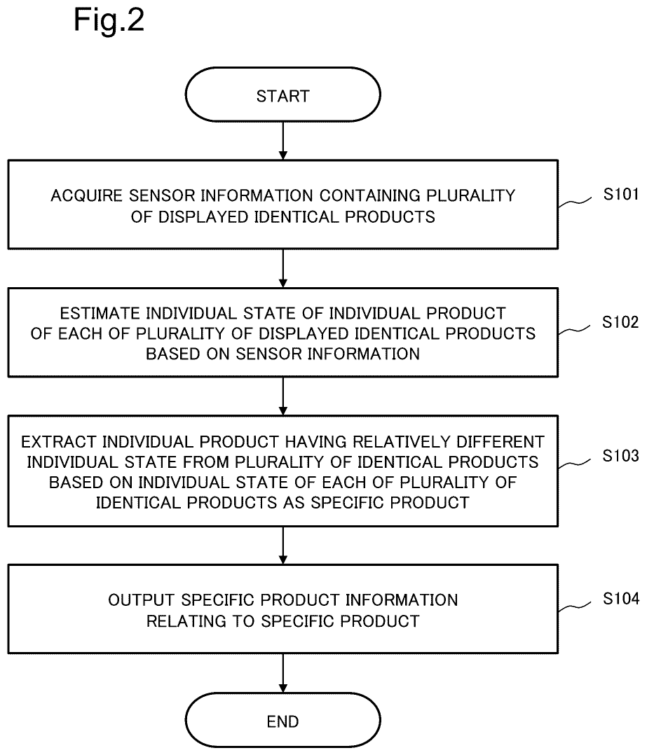

The operation of the product management device 100 configured as described above will be described with reference to the flowchart of FIG. 2.

FIG. 2 is a flowchart illustrating an outline of the operation of the product management device 100 according to the first example embodiment. The processing according to this flowchart may be executed based on program control by a processor.

As illustrated in FIG. 2, first, the acquisition unit 101 acquires sensor information containing a plurality of displayed identical products (step S101).

Next, the state estimation unit 102 estimates the individual state of the individual product of each of the plurality of displayed identical products based on the sensor information (step S102).

Next, the extraction unit 103 extracts an individual product having a relatively different individual state from the plurality of individual identical products as the specific product based on the individual state of each of the plurality of identical products (step S103).

Next, the output unit 104 outputs the specific product information relating to the specific product (step S104).

As described above, the product management device 100 ends a series of operations.

The product management device according to the present example embodiment described above includes the acquisition unit, the state estimation unit, the extraction unit, and the output unit. The acquisition unit acquires sensor information containing a plurality of displayed identical products. The state estimation unit estimates the individual state of the individual product of each of the plurality of displayed identical products based on the sensor information. The extraction unit extracts an individual product having a relatively different individual state from the plurality of individual identical products as the specific product based on the individual state of each of the plurality of identical products. Then, the output unit 104 outputs the specific product information relating to the specific product information.

As a result, the product management device according to the present example embodiment can manage a plurality of identical products according to individual differences. As a result, the product management device according to the present example embodiment can improve efficiency of work related to management according to individual differences of products. For example, the product management device according to the present example embodiment can improve efficiency of work related to management for appropriately selling a product considered to be unlikely to sell according to an individual difference of the product.

### Second Example Embodiment

Next, a second example embodiment of the present disclosure will be described in detail with reference to the drawings. Hereinafter, description of contents overlapping with the above description will be omitted to the extent that the description of the present example embodiment is not unclear.

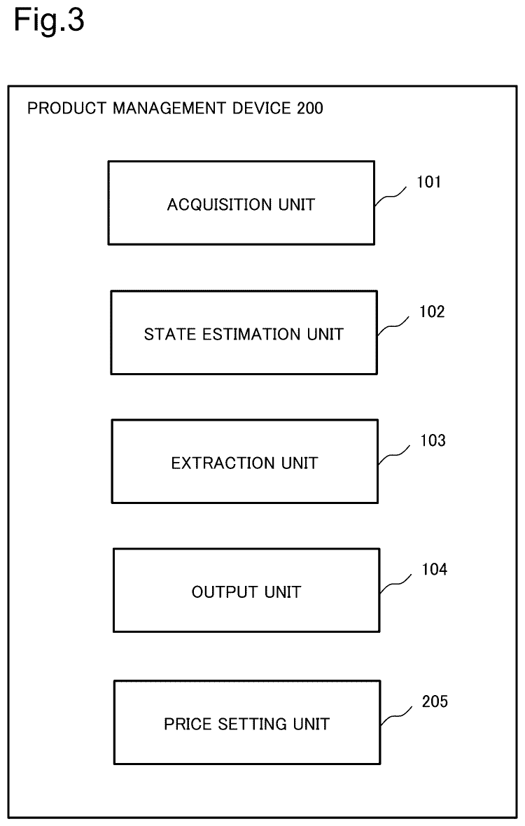

FIG. 3 is a block diagram illustrating a configuration of a product management device according to the second example embodiment of the present disclosure. A product management device 200 of the second example embodiment includes a price setting unit 205 in addition to the configuration of the first example embodiment.

The price setting unit 205 is an example of a price setting means that sets the price of the specific product based on the price information indicating the relationship between the price of the identical product and the individual state and the individual state of the specific product. The price information indicating the relationship between the price of the identical product and the individual state is set in advance, for example, for each week, day, and time. The price setting unit 205 sets the price of the specific product by referring to the price information based on the individual state of the specific product extracted by the extraction unit 103. The price information may be stored in the product management device 200 or a database connected to the product management device 200 via a network. Setting the price includes changing the price from a preset price.

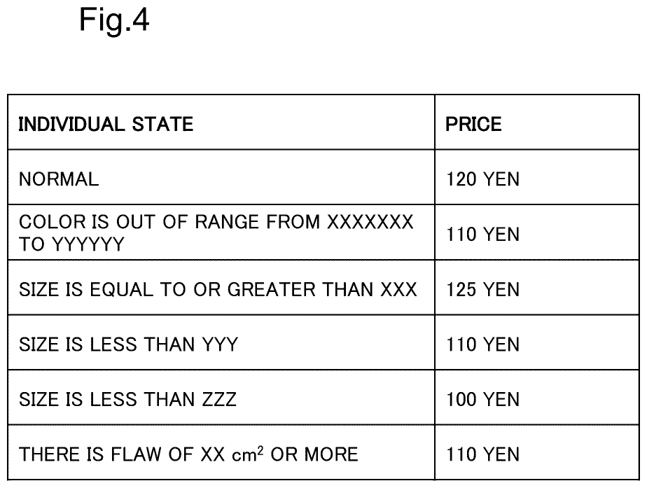

FIG. 4 illustrates an example of price information indicating the relationship between the price of the identical product and the individual state. FIG. 4 illustrates a price corresponding to an individual state of the identical product. According to FIG. 4, in a case where the individual state is normal, that is, in a case where the individual product is not extracted as the specific product, the price of the individual product is 120 yen. In FIG. 4, the price is represented according to the color, the size, and the presence or absence of a flaw. FIG. 4 illustrates an example of the price information, and the price information is not limited to these examples.

The extraction unit 103 may extract an individual product that is in an individual state indicated in the price information based on the price information and the individual state estimated by the state estimation unit 102.

The price setting unit 205 may set the price of the individual product according to a difference between the criterion and the individual state of the specific product. The criterion may be a criterion based on the individual state of the individual product. In this case, the price setting unit 205 may determine the price of the specific product based on the price information indicating the relationship between the price of the identical product and the difference between the criterion and the individual state of the specific product.

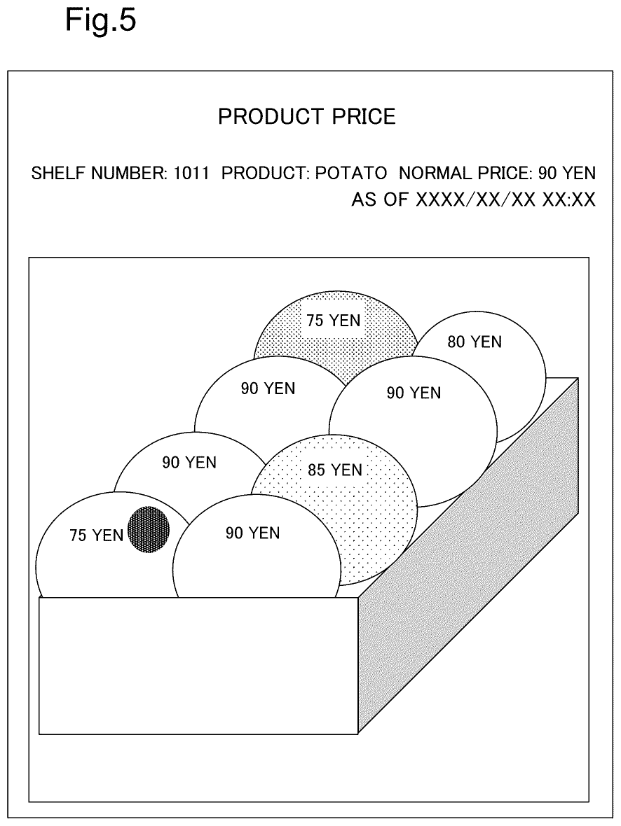

The output unit 104 outputs the price of the specific product as the specific product information relating to the specific product. FIG. 5 illustrates an example of the output of the price of the specific product.

In FIG. 5, the price is displayed for each product. The product may be indicated by an image acquired by the acquisition unit 101, or may be indicated by an illustration based on the image acquired by the acquisition unit 101. As illustrated in FIG. 5, the price of 75 yen and the price of 85 yen are displayed to be superimposed on the image of the products for a potato having a normal price of 90 yen and a potato having a color relatively different from the color of each of the plurality of displayed identical products. A price of 80 yen is displayed for a potato that is relatively small with respect to the size of each of the plurality of displayed identical products. A price of 75 yen is displayed for a potato having a flaw. These are the prices of the specific products, that is, the specific product information. As illustrated in FIG. 5, the price of the product other than the specific product may also be displayed. When the time changes, the individual state and the price of the identical product may change, and thus, as illustrated in FIG. 5, the time when the price is set may be indicated so that the user can recognize at which point the price is set.

Alternatively, the output unit 104 may output the identification information of the specific product and the price of the specific product as the specific product information. The output unit 104 may further output the reason for setting the price of the specific product. For example, the output unit 104 may output the identification information of the specific product and the price of the specific product to the list of purchased products in self-scan shopping in which a customer performs product registration of a purchased product while shopping in the shop. For example, the output unit 104 may output the identification information of the specific product and the price of the specific product to a seal issuing device as the specific product information. In this case, the output unit 104 may output a two-dimensional code including the identification information of the specific product and the price of the specific product to the seal issuing device as the specific product information. For example, the output unit 104 may output the two-dimensional code including the identification information of the specific product and the price of the specific product as the specific product information to a printing device using the edible ink.

The price setting unit 205 may set a price range of the specific product based on the price information and the individual state of the specific product. In this case, the price information includes a price range as the price of the identical product. In a case where the price setting unit 205 sets a price range, the output unit 104 outputs the price range of the specific product to the user who uses the product management device 200.

For example, the output unit 104 outputs the price range of the specific product to a store clerk who is a user using the product management device 200. The store clerk who is a user using the product management device 200 may determine the price of the specific product in the output price range of the specific product.

In a case where the price setting unit 205 sets a price range, the price setting unit 205 may determine the price according to the individual state estimated based on the sensor information acquired again for more appropriate price setting. Hereinafter, an example of determining a price using an image as the sensor information will be described. In a case where the price setting unit 205 determines the price according to the individual state estimated based on the reacquired sensor information, the image may be read as the sensor information, the image capturing may be read as the detection, and the imaging instruction may be read as the detection instruction in the following description.

In this case, the output unit 104 further outputs, to the store clerk or the customer who is a user, an imaging instruction for capturing a specific product image that is an image of the specific product, in addition to the price range of the specific product. The imaging instruction is an instruction to cause the specific product to be captured closer than the image including the plurality of displayed identical products. The imaging instruction may be an instruction to cause the specific product to be captured from a plurality of directions. The acquisition unit 101 further acquires a specific product image captured based on the imaging instruction. The state estimation unit 102 estimates the individual state again based on the acquired specific product image. Then, the price setting unit 205 sets the price of the specific product based on the price information indicating the relationship between the price of the identical product and the individual state and the individual state of the specific product. The price setting unit 205 may further set the price of the specific product within the previously set price range. The processing of outputting the imaging instruction of the specific product and re-estimating the individual state may be performed in a case where the individual state of the specific product is not sufficiently estimated. The case where the individual state of the individual product is not sufficiently estimated is, for example, a case where it is estimated that a part or most of the individual product is hidden in an image including a plurality of identical products.

The individual state is more appropriately estimated by the processing of outputting the imaging instruction and re-estimating the individual state. Therefore, it is possible to more appropriately manage the individual product according to the individual state by the processing of outputting the imaging instruction and re-estimating the individual state.

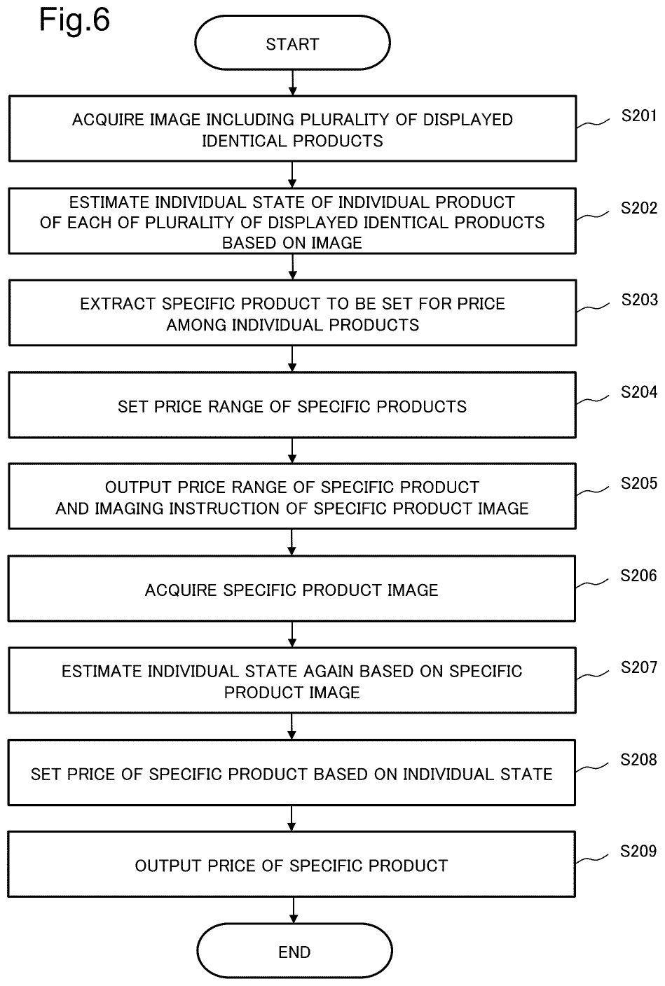

The operation of the product management device 200 configured as described above will be described with reference to the flowchart of FIG. 6.

FIG. 6 is a flowchart illustrating an example of the operation of the product management device 200 according to the second example embodiment. The processing according to this flowchart may be executed based on program control by a processor.

As illustrated in FIG. 6, first, the acquisition unit 101 acquires an image including a plurality of displayed identical products (step S201).

Next, the state estimation unit 102 estimates the individual state of the individual product of each of the plurality of displayed identical products based on the image (step S202).

Next, the extraction unit 103 extracts a specific product for which the price setting is to be performed among the individual products (step S203). In a case where the specific product for which the price setting is to be performed is not extracted in step S203, the output unit 104 may output that the specific product is not extracted, and the product management device 200 may end the operation.

Next, the price setting unit 205 sets the price range of the specific product based on the individual state and the price information of the specific product (step S204).

Next, the output unit 104 outputs the price range of the specific product and the imaging instruction of the specific product image set in step S204 (step S205).

Next, the acquisition unit 101 acquires the specific product image captured by the user based on the imaging instruction (step S206).

Next, the state estimation unit 102 re-estimates the individual state based on the specific product image (step S207).

Next, the price setting unit 205 sets the price of the specific product based on the re-estimated individual state and price information of the specific product (step S208).

Then, the output unit 104 outputs the set price of the specific product (step S209).

As described above, the product management device 200 ends a series of operations.

The product management device according to the present example embodiment described above includes the acquisition unit, the state estimation unit, the extraction unit, the output unit, and the price setting unit. The acquisition unit acquires sensor information containing a plurality of displayed identical products. The state estimation unit estimates the individual state of the individual product of each of the plurality of displayed identical products based on the sensor information. The extraction unit extracts an individual product having a relatively different individual state from the plurality of identical products as the specific product based on the individual state of each of the plurality of identical products. The price setting unit sets the price of the specific product based on the price information indicating the relationship between the price of the identical product and the individual state and the individual state of the specific product. Then, the output unit 104 outputs the specific product information relating to the specific product information.

As a result, the product management device according to the present example embodiment can manage a plurality of identical products according to individual differences.

In particular, the product management device according to the present example embodiment can set a price according to an individual difference among a plurality of identical products. For example, by appropriately setting the price according to the individual difference of the product, it is possible to improve the customer's acceptance and satisfaction with the price of the purchased product. For example, by appropriately setting the price according to the individual difference of the product, a product that is unlikely to sell due to the individual difference is easy to sell.

Furthermore, the product management device according to the present example embodiment can improve the efficiency of the work of a store clerk regarding the price setting according to the individual difference of the product. That is, the product management device according to the present example embodiment enables a store clerk who is a user to easily find a specific product that can be priced among a plurality of identical products.

The product management device according to the present example embodiment can support a customer to find a product to be purchased from the identical products having individual differences. That is, an individual product having a relatively different individual state is extracted as the specific product, and the price or the price range is output as the specific product information, whereby the customer can easily find a product whose price is low, for example.

### First Modification

Next, a first modification of the second example embodiment will be described.

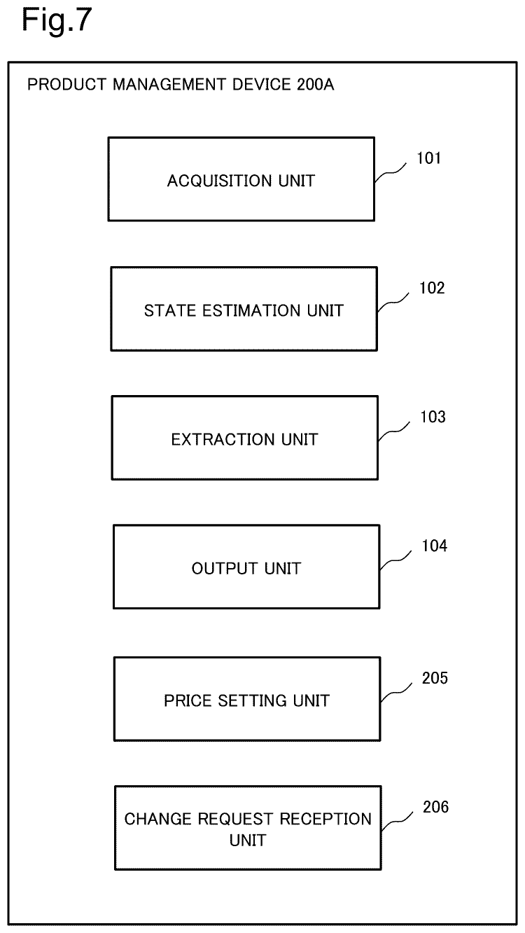

FIG. 7 is a block diagram illustrating a configuration of a product management device 200A according to the first modification of the second example embodiment. The product management device 200A according to the first modification may further include a change request reception unit 206 in addition to the configuration of the product management device 200 according to the second example embodiment.

The change request reception unit 206 is an example of a change request reception means that receives a price change request that is a change request of the price of the specific product of which the specific product information is output by the output unit 104. In this case, the specific product information includes a price or a price range. The change request reception unit 206 receives, for example, a price change request by the user who has output the price or the price range of the specific product from a touch panel display provided in the terminal device. The user who inputs the price change request is a store clerk or a customer. The price change request may include a reason for the change request. For example, in a case where the reason for the change request is the appearance of the product, the change request reception unit 206 may receive, as the reason for the change request, an image including a portion of the product as the reason for the change request.

The price setting unit 205 sets the price of the specific product based on the price change request received by the change request reception unit 206, the price information, the individual state of the specific product, and the preset allowable range of the price. The allowable range of the price is a range of price allowed in product price setting. The price setting unit 205 sets the price or the price range of the specific product within the allowable range of the price. The allowable range of the price may be set in advance for each product. Alternatively, the allowable range of the price may be set within a predetermined ratio from the standard price for each of all the products or the product categories.

When the change request reception unit 206 receives the price change request and the price setting unit 205 sets the price, the product management device 200A according to the present modification can more appropriately set the price of the individual product according to the individual state. As a result, for example, the product management device 200A can improve the customer's acceptance and satisfaction with the price of the individual product, for example. For example, the product management device 200A can support more appropriate price setting of the individual product according to the individual state by the store clerk.

### Second Modification

Next, a second modification of the present disclosure will be described.

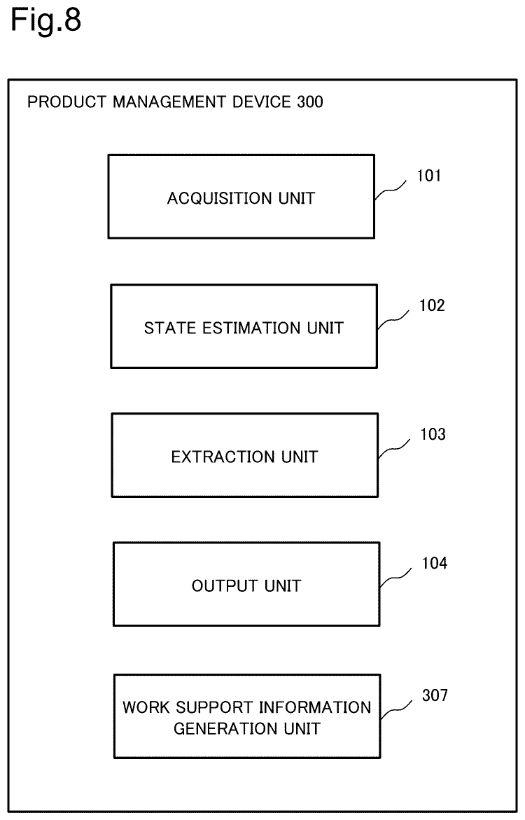

FIG. 8 is a block diagram illustrating a configuration of a product management device according to the second modification of the present disclosure. A product management device 300 of the second modification includes a work support information generation unit 307 in addition to the configuration of the first example embodiment.

The work support information generation unit 307 generates work support information according to an individual state of the individual product of each of the plurality of displayed identical products. The work support information is, for example, information relating to the price of the individual product, information relating to the display place of the individual product, and information relating to the sales of the individual product. The output unit 104 outputs the work support information.

The work support information generation unit 307 generates, for example, information relating to the setting of the price of the individual product. For example, the work support information is information for supporting price setting work by a store clerk, more specifically, product price reduction work by a store clerk. The work support information generation unit 307 that generates the information relating to the price of the individual product has the function of the price setting unit 205 in the second example embodiment. In this case, the work support information generation unit 307 generates the work support information containing the specific product for which the price is to be set and the price to be set based on the price information indicating the relationship between the price of the identical product and the individual state and the individual state of the specific product. The work support information generation unit 307 may generate work support information containing a price setting reason in addition to the specific product for which the price is to be set and the price to be set.

The work support information generation unit 307 generates, for example, information relating to a display place of an individual product. For example, the work support information is information for supporting product display work by a store clerk. More specifically, the work support information is information for supporting the work of specifying clearance goods to be displayed on a dedicated shelf. Clearance goods are products that are reduced in price because they are not expected to sell well. Based on display place information indicating a display place according to a preset individual state and an individual state of a specific product whose display place is to be changed, the work support information generation unit 307 outputs work support information containing the specific product whose display place is to be changed and the display place of the specific product. The display place information may include, as information indicating the display place according to the individual state, not displaying the product that is in the individual state showing that the product cannot be sold. The individual state in which the product cannot be sold is, for example, a state in which the flaw of the product is large or a state in which the degree of flaw of the product is large.

That is, the output unit 104 outputs information relating to the display place of the specific product based on the display place information indicating the display place according to the individual state. The work support information generation unit 307 generates the information relating to the display place of the individual product, and the output unit 104 outputs the information relating to the display place of the specific product, whereby the product management device 300 can efficiently manage the display place according to the individual difference of the product by the store clerk. That is, the product management device 300 can save the store clerk from checking the individual difference of the product and examining the display place according to the situation difference of the product.

The work support information generation unit 307 generates, for example, sales information relating to sales of individual products. The work support information generation unit 307 that generates sales information is also referred to as a sales information generation unit. The sales information generation unit is an example of sales information generation means that specifies sales of the individual product based on the sensor information and the individual state in the store, and generates sales information in which the sales of the specified individual product and the individual state are associated with each other. The sales information generation unit first specifies an individual product carried away from the product shelf based on a temporal change in sensor information containing a plurality of displayed identical products. The product carried away from the product shelf is estimated to be a product purchased by the customer. An individual product that has been carried away from the product shelf for a certain period of time may be specified based on a temporal change in sensor information containing a plurality of displayed identical products. The sales information generation unit generates, as sales information, an individual state of the individual product carried away from the product shelf and an individual state of the remaining individual product. The sales information generation unit may specify a sales trend according to the individual state based on the individual state of the individual product carried away from the product shelf and the individual states of the remaining individual products. Then, the sales information generation unit may generate a sales trend according to the individual state as the sales information. In this case, the output unit 104 may output the sales information in response to a request of the user.

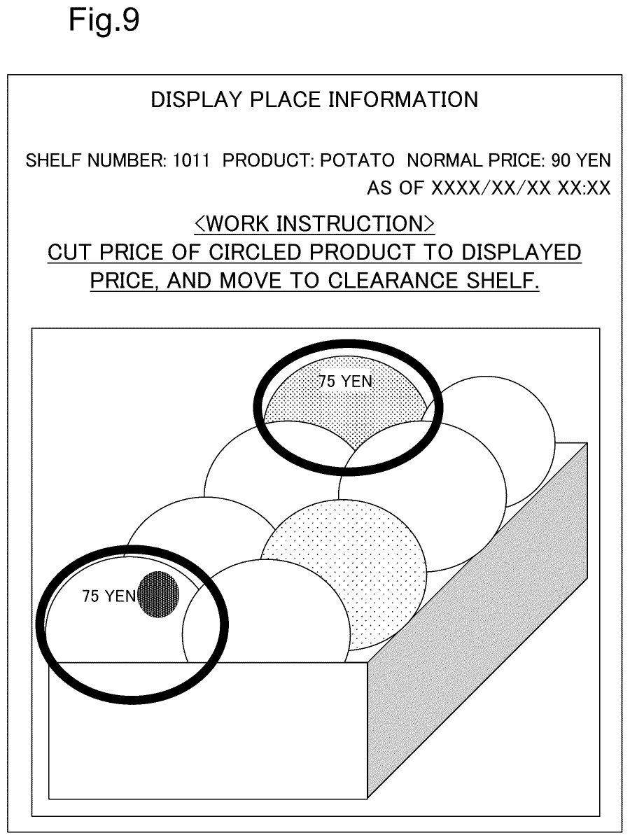

FIG. 9 is an example of output of work support information. In FIG. 9, a price according to an individual state of a specific product and a display place according to the individual state are displayed as the work support information. As illustrated in FIG. 9, the price of 75 yen for a potato having a relatively different color and the price of 75 yen for a potato having a flaw are displayed on a specific product in the image. A potato having a relatively different color as a specific product and a potato having a flaw are circled and displayed in an identifiable manner. Further, in FIG. 9, a work instruction for the specific product is displayed as the work support information. Similarly to FIG. 5, the product may be indicated by the image acquired by the acquisition unit 101, or may be indicated by an illustration based on the image acquired by the acquisition unit 101. As in FIG. 5, since the individual state and the prices of the identical products may change when the time changes, the prices and the time when the display place are set may be indicated in order for the user to know at which point the prices and the display place are set.

The work support information generation unit 307 generates the sales information in which the individual state of the individual product is associated with the sales of the individual product, and the output unit 104 outputs the sales information, whereby the product management device 300 can provide the sales information corresponding to the individual difference to the store clerk. That is, the product management device 300 can provide the store clerk with information relating to sales of a product according to individual differences such as purchase and display of the product.

### Hardware Configuration

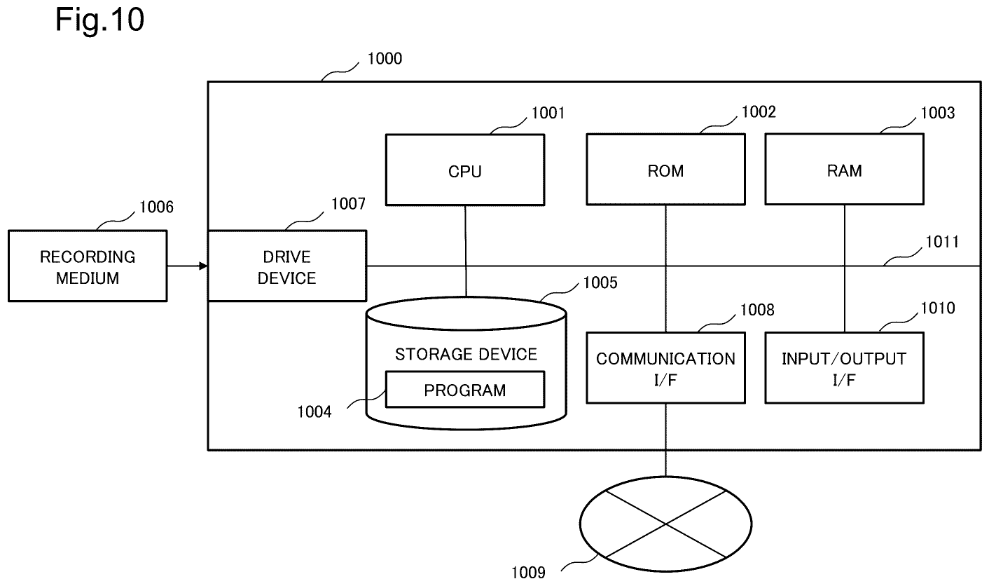

A part or all of each component of each apparatus or system in each example embodiment of the present disclosure described above is achieved by, for example, any combination of an information processing device 1000 and a program as illustrated in FIG. 10. As an example, the information processing device 1000 includes the following configurations.
CPU(Central Processing Unit) 1001
ROM(Read Only Memory) 1002
RAM(Random Access Memory) 1003
Program 1004 loaded into RAM 1003
Storage device 1005 storing program 1004
Drive device 1007 for reading recording medium 1006
Communication I/F 1008 connected to communication network 1009
Input/output I/F 1010 for inputting/outputting data
Bus 1011 connecting each component

The I/F is an abbreviation of Interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the method of achieving each device. For example, each device or system may be achieved by any combination of the information processing device 1000 and the program separate for each component. A plurality of components included in each device may be achieved by any combination of one information processing device 1000 and a program.

Some or all of the components of each device or system are achieved by general-purpose or dedicated circuitry including a processor or the like, or a combination thereof. The circuit is, for example, a CPU, a graphics processing unit (GPU), a field programmable gate array (FPGA), or a large scale integration (LSI). The LSI is, for example, an LSI dedicated to artificial intelligence (AI) processing. These may be configured by a single chip or may be configured by a plurality of chips connected via a bus. Some or all of the components of each device may be achieved by a combination of the above-described circuit and the like and a program.

In a case where some or all of the components of each device or system are achieved by a plurality of information processing devices, circuits, and the like, the plurality of information processing devices, circuits, and the like may be arranged in a centralized manner or in a distributed manner. For example, the information processing device, the circuit, and the like may be achieved as a form in which each is connected via a communication network, such as a client and server system or a cloud computing system.

Although the present invention has been described with reference to each example embodiment, the present invention is not limited to the above example embodiments. Various modifications that can be understood by those of ordinary skill in the art can be made to the configuration and details of the present invention within the scope of the present invention.

For example, the product management device may be changed to a product management device in which the work support information generation unit 307 is included in the product management device 200 of the second example embodiment or the product management device 200A of the first modification.

Although the plurality of operations is described in order in the form of a flowchart, the order of description does not limit the order of executing the plurality of operations. Therefore, when each example embodiment is implemented, the order of the plurality of operations may be changed within a range that does not interfere with the content.

### REFERENCE SIGNS LIST

100 product management device
101 acquisition unit
102 state estimation unit
103 extraction unit
104 output unit
200 product management device
205 price setting unit
200A product management device
206 change request reception unit
300 product management device
307 work support information generation unit
1000 information processing device
1001 CPU
1002 ROM
1003 RAM
1004 program
1005 storage device
1006 recording medium
1007 drive device
1008 communication I/F
1009 communication network
1010 input/output I/F
1011 bus

What is claimed is:

1. A product management device comprising:
one or more memories storing instructions; and
one or more processors configured to execute the instructions to:
acquire sensor information containing a plurality of displayed identical products;
estimate, based on the sensor information, an individual state of an individual product of each of the plurality of displayed individual identical products;
extract a specific product that is an individual product having a relatively different individual state from the plurality of individual identical products based on the individual state of each of the plurality of identical products; and
output specific product information relating to the specific product.

2. The product management device according to claim 1, wherein the one or more processors configured to execute the instructions to:
set a price of the specific product based on price information indicating a relationship between a price of the identical product and the individual state and the individual state of the specific product.

3. The product management device according to claim 2, wherein the one or more processors configured to execute the instructions to:
output a price of the specific product as specific product information relating to the specific product.

4. The product management device according to claim 2, wherein the one or more processors configured to execute the instructions to:
set a price range of the specific product based on the price information and the individual state of the specific product.

5. The product management device according to claim 4, wherein the one or more processors configured to execute the instructions to:
output the price range of the specific product as the specific product information.

6. The product management device according to claim 1, wherein the one or more processors configured to execute the instructions to:
further output a detection instruction for causing a user to detect specific product sensor information that is sensor information of the specific product.

7. The product management device according to claim 6, wherein the one or more processors configured to execute the instructions to:
further acquire the specific product sensor information detected based on the detection instruction, and
estimate the individual state again based on the specific product sensor information.

8. The product management device according to claim 2, wherein the one or more processors configured to execute the instructions to:
receive a change request for a price of the specific product of which the specific product information is output by the output means and a price change request including a reason for change, wherein
set a price based on the price change request.

9. The product management device according to claim 8, wherein the one or more processors configured to execute the instructions to:
set a price of the specific product based on the price change request, the price information, the individual state of the specific product, and an allowable range of a preset price.

10. The product management device according to claim 2, wherein the one or more processors configured to execute the instructions to:
set a price of the individual product according to a difference between the individual state of the individual product and the individual state of the specific product.

11. The product management device according to claim 1, wherein the one or more processors configured to execute the instructions to:
superimpose and display the specific product information on the displayed specific product.

12. The product management device according to claim 1, wherein the one or more processors configured to execute the instructions to:
project the specific product information onto a detection range of the sensor information.

13. The product management device according to claim 1, wherein the one or more processors configured to execute the instructions to:
output identification information of the specific product and the specific product information.

14. The product management device according to claim 2, wherein the one or more processors configured to execute the instructions to:
further output identification information of the specific product, the price of the specific product, and a setting reason of the price of the specific product.

15. The product management device according to claim 1, wherein the one or more processors configured to execute the instructions to:
output presence or absence of the specific product as the specific product information.

16. The product management device according to claim 1, wherein the one or more processors configured to execute the instructions to:
generate work support information according to the individual state of each of a plurality of identical products; and
output the work support information as the specific product information.

17. (canceled)

18. The product management device according to claim 16, wherein the one or more processors configured to execute the instructions to:
generate work support information containing the specific product for which a price is to be set and a price to be set based on price information indicating a relationship between a price of the identical product and the individual state and the individual state of the specific product.

19-21. (canceled)

22. The product management device according to claim 1, wherein the one or more processors configured to execute the instructions to:
estimate at least one of a size, a color, presence or absence of a flaw, a shape, a best-before date, and an arrival date of the individual product as the individual state based on the sensor information.

23. (canceled)

24. A product management method causing a computer to execute:
acquiring sensor information containing a plurality of displayed identical products;
estimating, based on the sensor information, an individual state of an individual product of each of the plurality of displayed individual identical products;
extracting a specific product that is an individual product having a relatively different individual state from the plurality of individual identical products based on the individual state of each of the plurality of identical products; and
outputting specific product information relating to the specific product.

25. A non-transitory computer-readable recording medium having stored therein a program to cause a computer to execute:
acquiring sensor information containing a plurality of displayed identical products;
estimating, based on the sensor information, an individual state of an individual product of each of the plurality of displayed individual identical products;
extracting a specific product that is an individual product having a relatively different individual state from the plurality of individual identical products based on the individual state of each of the plurality of identical products; and
outputting specific product information relating to the specific product.
